(19) United States
(12) Patent Application Publication
(10) Pub. No.: US 2024/0369022 A1
(43) Pub. Date: Nov. 7, 2024

(54) TORQUE EXTRACTION SYSTEMS, TURBINE ENGINES, AND METHODS FOR EXTRACTING TORQUE FROM TURBINE ENGINES

(71) Applicant: General Electric Company, Schenectady, NY (US)

(72) Inventors: Kudum Shinde, Bengaluru (IN); Prateek Jalan, Bengaluru (IN); Sharad Pundik Patil, Bengaluru (IN); Ravindra Shankar Ganiger, Bengaluru (IN)

(73) Assignee: General Electric Company, Schenectady, NY (US)

(21) Appl. No.: 18/440,063

(22) Filed: Feb. 13, 2024

(30) Foreign Application Priority Data
May 1, 2023 (IN) 202311031037

(51) Int. Cl. F02C 7/32; F01D 15/10

(52) U.S. Cl. CPC F02C 7/32; F01D 15/10; F05D 2220/76; F05D 2260/4023; F05D 2260/4031

(57) ABSTRACT

A torque extraction system for a turbine engine includes an electric machine coupled to a shaft of the turbine engine by way of a gearbox disposed between the electric machine and the shaft of the turbine engine, and the electric machine draws torque from the shaft and converts the torque to electrical energy. A power bus is electrically coupled to the electric machine and provides power to the electric machine. A sensor senses vibrational forces acting on a rotor of the turbine engine, and a controller electrically coupled to the electric machine receives signals from the sensor corresponding to the sensed vibrational forces. The controller operates the gearbox disposed between the electric machine and the shaft of the turbine engine to increase the torque that the electric machine draws from the shaft when the vibrational forces sensed by the sensor meet or exceed a predetermined threshold.

### CROSS-REFERENCE TO RELATED APPLICATION

This application claims priority to Indian application No. 202311031037 filed on May 1, 2023, the entire contents of which is hereby incorporated by reference.

### TECHNICAL FIELD

The present specification generally relates to turbine engines and, more specifically, to torque extraction systems for turbine engines.

### BACKGROUND

During certain operating conditions of a turbine engine, a rotor of the turbine engine may be subjected to a variety of axial loads. For example, at high operating speeds, a substantial axial load may act on the rotor in an aft direction, while the axial load may be diminished and/or reversed at low and idling speeds. As the axial load on the rotor is reduced, vibrational forces are often observed acting on the rotor. Over time, if the vibrational forces continue to act on the rotor, the rotor may experience cycle fatigue, which may lead to degradation of the rotor and/or other components of the turbine engine.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of an exemplary embodiment of a turbine engine, according to one or more embodiments shown and described herein;

FIG. 2 schematically depicts an illustrative torque extraction system of the turbine engine of FIG. 1, according to one or more embodiments shown and described herein;

FIG. 3 schematically depicts a flow diagram of an illustrative method for extracting torque from the turbine engine using the torque extraction system of FIG. 2, according to one or more embodiments shown and described herein;

FIG. 4 schematically depicts another illustrative torque extraction system, according to one or more embodiments shown and described herein;

FIG. 5 schematically depicts a flow diagram of a method of extracting torque from the turbine engine using the torque extraction system of FIG. 4, according to one or more embodiments shown and described herein;

FIG. 6 schematically depicts another illustrative torque extraction system, according to one or more embodiments shown and described herein; and

FIG. 7 schematically depicts a flow diagram of a method of extracting torque from the turbine engine using the torque extraction system of FIG. 6, according to one or more embodiments shown and described herein.

### DETAILED DESCRIPTION

Embodiments described herein are directed to turbine engines, torque extraction systems, and methods of extracting torque from a turbine engine. A turbine engine may include a high pressure rotor including a high pressure compressor and high pressure turbine coupled together via a high pressure shaft. The turbine engine may further include a torque extraction system including an electric machine, a gearbox, and a controller having a sensor. The high pressure shaft may connect the torque extraction system to the high pressure rotor, and a sensor of the torque extraction system may be used to track vibrational forces acting on the high pressure rotor. The controller may receive the vibrational forces and monitor the vibrational forces to ensure that the vibrational forces acting on the high pressure rotor remain beneath a predetermined threshold. In the event the vibrational forces acting on the high pressure rotor exceed the predetermined threshold, the electric machine may increase a torque demand on the high pressure shaft to extract torque from the high pressure shaft. As the torque is extracted from the high pressure shaft, axial thrust may be applied to the high pressure rotor in an aft direction, causing the vibrational forces of the high pressure rotor to decrease. Torque may continue to be extracted from the high pressure shaft until the vibrational forces acting on the high pressure rotor drops below the predetermined threshold.

As described herein, a discharge pressure of a turbine engine may vary broadly, such as, for example, a normal operating range of a turbine engine from a low or idling speed to maximum speed of the engine. This variation in operating conditions causes a substantial variation in the axial force exerted on the rotor of a turbine engine. Thus, at certain (e.g., high) operating speeds, there may be a substantial axial load on the rotor in an aft or forward direction. On the other hand, at other (e.g., low or idling) speeds, this axial force on the rotor is substantially reduced and may shift to the opposite direction, resulting in a condition known as crossover, occurring at a time when the force exerted on the rotor changes from an aft direction to a forward direction or vice versa.

During certain engine conditions, vibrational forces may be observed on the rotor of a turbine engine. For example, vibrational forces are typically observed when the axial load on the rotor of the turbine is small, zero, or at the thrust crossover condition, as has been described herein. If left unchecked, the vibrational forces acting on the rotor can result in non-synchronous vibration issues within the turbine engine. Furthermore, rotors that frequently experience vibrational forces may suffer from high cycle fatigue, which may shorten the life cycle of the rotor or other components of the turbine engine. By implementing a torque extraction system in the turbine engine, it may be possible to monitor vibrational forces acting on a rotor during operation of a turbine engine to ensure that the vibrational forces remain below a predetermined threshold in order to reduce or minimize the aforementioned high cycle fatigue. Furthermore, in the event the vibrational forces exceed the predetermined threshold, the torque extraction system may be operable to extract torque from the rotor to bring the vibrational forces below the predetermined threshold, thereby alleviating potential problems arising from non-synchronous vibration and high cycle fatigue.

Various embodiments of turbine engines, torque extraction systems, and methods of extracting torque from a turbine engine are described in more detail herein. Whenever possible, the same reference numerals will be used throughout the drawings to refer to the same or like parts.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first,” and “second,” may be used interchangeably to distinguish one component from another and are not intended to signify location or importance of the individual components.

The terms “forward” and “aft” refer to relative positions within a gas turbine engine or vehicle, and refer to the normal operational attitude of the turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

The singular forms “a,” “an,” and “the” include plural references unless the context clearly dictates otherwise.

Here and throughout the specification and claims, range limitations are combined and interchanged, Such ranges are identified and include all the sub-ranges contained therein unless context or language indicates otherwise. For example, all ranges disclosed herein are inclusive of the endpoints, and the endpoints are independently combinable with each other.

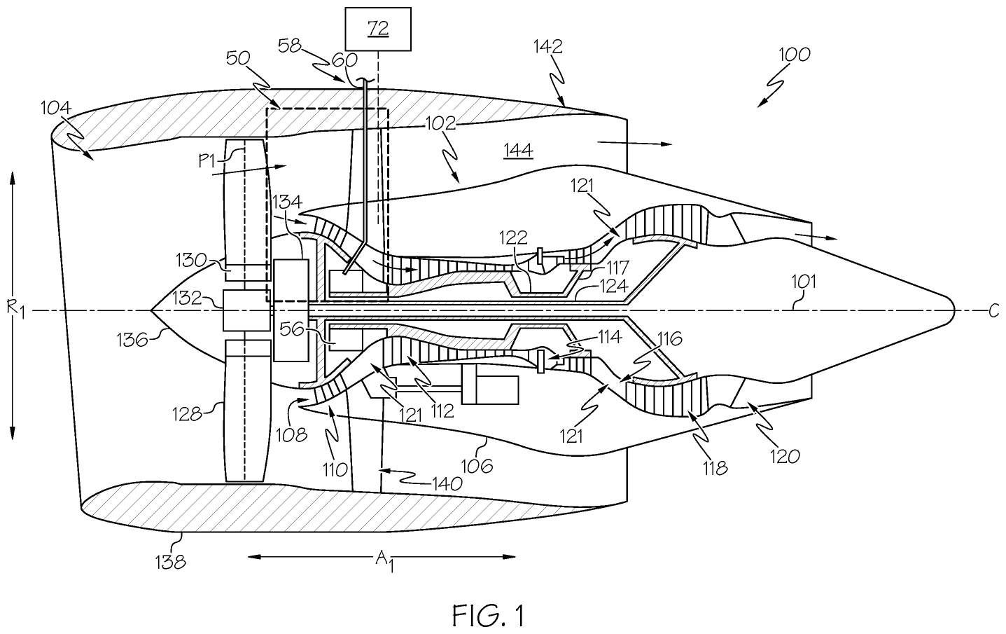

Referring now to FIG. 1, a turbine engine 100 suitably designed to be mounted to a wing or fuselage of an aircraft is depicted. The turbine engine 100 may include a torque extraction system 50. In embodiments, the torque extraction system 50 may include an electric machine 56 (e.g., an electric motor or generator), a controller 76, and a power bus 58. In these embodiments, a plurality of electric lines 60 may be used to electrically couple the electric machine 56 to the power bus 58. For example, the power bus 58 may include various switches or other power electronics movable to electrically connect the various components of the turbine engine 100. Additionally, the power bus 58 may further include power electronics, such as inverters, converters, rectifiers, etc., for conditioning or converting electrical power within the turbine engine 100.

In these embodiments, the torque extraction system 50 may monitor nominal transient vibrational forces that occur within the turbine engine 100 during a particular flight envelope (e.g., takeoff, cruise, descent, landing, etc.) to ensure that the vibrational forces remain below a predetermined threshold. In the event the predetermined threshold is met or exceeded, the electric machine 56 may extract torque generated by the turbine engine 100 in order to increase thrust in an aft direction and maintain transient vibrational forces below the predetermined threshold, as will be described in additional detail herein.

Referring still to FIG. 1, the turbine engine 100 may further include a turbomachine 102 and a prime propulsor, the prime propulsor being a fan (referred to as “fan 104” with reference to FIG. 1). As stated, the turbine engine 100 includes the fan 104 and the turbomachine 102 disposed downstream (e.g., in the +x direction as depicted in the coordinate axis of FIG. 1) from the fan 104. In these embodiments, the turbine engine 100 may also define an axial direction A1 (extending parallel to a longitudinal centerline C provided for reference) and a radial direction R1.

Referring still to FIG. 1, the turbomachine 102 may include a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a first, high pressure (HP) turbine 116 and a second, low pressure (LP) turbine 118; and a jet exhaust nozzle section 120. The compressor section, combustion section 114, and turbine section together define at least in part a core air flowpath 121 through the turbomachine 102.

The turbomachine 102 of the turbine engine 100 additionally includes one or more shafts rotatable with at least a portion of the turbine section and, for the embodiment depicted, at least a portion of the compressor section. More particularly, for the embodiment depicted, the turbine engine 100 includes a high pressure (HP) shaft 122, which drivingly connects the HP turbine 116 to the HP compressor 112. In these embodiments, the HP turbine 116, HP compressor 112, and HP shaft 122 may be referred to as a high pressure rotor 117. Additionally, the exemplary turbine engine 100 includes a low pressure (LP) shaft 124, which drivingly connects the LP turbine 118 to the LP compressor 110.

Further, the exemplary fan 104 depicted is configured as a variable pitch fan having a plurality of fan blades 128 coupled to a disk 130 in a spaced apart manner. The fan blades 128 extend outwardly from disk 130 generally along the radial direction R1. Each fan blade 128 is rotatable relative to the disk 130 about a respective pitch axis PI by virtue of the fan blades 128 being operatively coupled to a suitable actuation member 132 configured to collectively vary the pitch of the fan blades 128. The fan 104 is mechanically coupled to the LP shaft 124, such that the fan 104 is mechanically driven by the second, LP turbine 118.

Referring still to the FIG. 1, the disk 130 is covered by a rotatable front hub 136 aerodynamically contoured to promote an airflow through the plurality of fan blades 128. Additionally, the turbine engine 100 includes an annular fan casing or outer nacelle 138 that circumferentially surrounds the fan 104 and/or at least a portion of the turbomachine 102. Accordingly, the exemplary turbine engine 100 depicted may be referred to as a “ducted” turbofan engine. Moreover, the nacelle 138 is supported relative to the turbomachine 102 by a plurality of circumferentially-spaced outlet guide vanes 140. A downstream section 142 of the nacelle 138 extends over an outer portion of the turbomachine 102 so as to define a bypass airflow passage 144 therebetween.

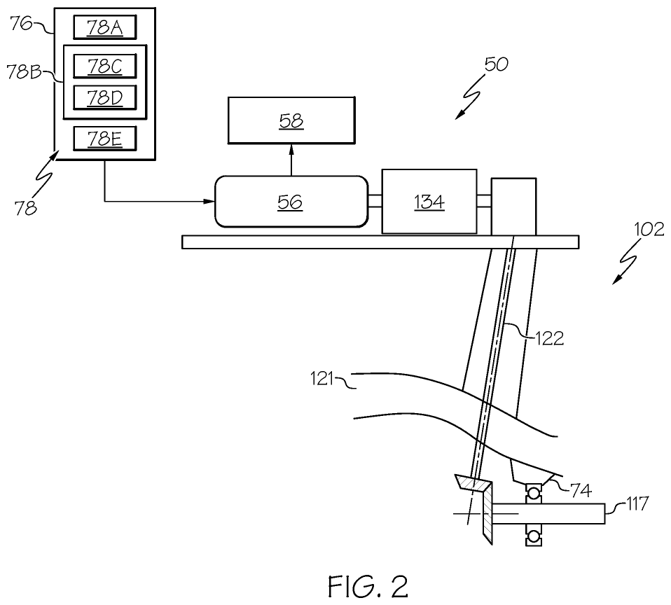

Referring now to FIGS. 1 and 2, an embodiment of the torque extraction system 50 is depicted. In these embodiments, the electric machine 56 of the torque extraction system 50 is positioned within the turbomachine 102 of the turbine engine 100, inward of the core air flowpath 121, and is in mechanical communication with one of the systems of the turbomachine 102. For example, for the embodiment depicted, the electric machine 56 is driven by the high pressure rotor 117.

More specifically, as shown in FIG. 2, the electric machine 56 may be driven by the HP turbine 116 (FIG. 1) through the HP shaft 122. In these embodiments, the electric machine 56 may be coupled to the HP shaft 122 through a gearbox 134, such as an accessory gearbox, which may include a plurality of gears for adjusting the rotational speed of the HP shaft 122. In these embodiments, the gearbox 134 may transfer rotational power from the HP shaft 122 to the electric machine 56 in the form of electrical power. Conversely, the electric machine 56 may be configured to convert electrical power into mechanical (e.g., rotational) power for the HP shaft 122.

Referring still FIG. 2, the torque extraction system 50 may further include the controller 76 and a sensor, such as a plurality of sensors 74. As should be appreciated, the controller 76 may be configured to distribute electrical power between the various components of the torque extraction system 50. For example, the controller 76 may be operable with the power bus 58 (including the one or more switches or other power electronics) to provide electrical power to, or draw electrical power from, the various components, such as the electric machine 56 and gearbox 134, to operate the torque extraction system 50 between various operating modes and perform various functions. Such is depicted schematically as the electric lines 60 (FIG. 1) of the power bus 58 extending through the controller 76 (FIG. 1). In these embodiments, the controller 76 may be an engine controller for the turbine engine 100 (e.g., a Full Authority Digital Engine Control (FADEC)), an aircraft controller, a controller dedicated to the torque extraction system 50, etc.

A controller 76 may be configured to receive data indicative of various operating conditions and parameters of the torque extraction system 50 during operation of the turbine engine 100 (FIG. 1). For example, the plurality of sensors 74 may be configured to sense data indicative of various operating conditions and parameters of various components of the turbine engine 100, such as rotational speeds, temperatures, pressures, vibrations, etc. More specifically, however, for the exemplary embodiment depicted in FIG. 2, the sensors 74 may be configured to sense data indicative of one or more parameters of the HP rotor 117. For example, the sensors 74 may be configured to sense data indicative of transient vibrations in the HP rotor 117.

Referring particularly to the operation of the controller 76, in at least certain embodiments, the controller 76 can include one or more computing device(s) 78. The computing device(s) 78 can include one or more processor(s) 78A and one or more memory device(s) 78B. The one or more processor(s) 78A can include any suitable processing device, such as a microprocessor, microcontroller, integrated circuit, logic device, and/or other suitable processing device. The one or more memory device(s) 78B can include one or more computer-readable media, including, but not limited to, non-transitory computer-readable media, RAM, ROM, hard drives, flash drives, and/or other memory devices.

The one or more memory device(s) 78B can store information accessible by the one or more processor(s) 78A, including computer-readable instructions 78C that can be executed by the one or more processor(s) 78A. The instructions 78C can be any set of instructions that when executed by the one or more processor(s) 78A, cause the one or more processor(s) 78A to perform operations. In some embodiments, the instructions 78C can be executed by the one or more processor(s) 78A to cause the one or more processor(s) 78A to perform operations, such as any of the operations and functions for which the controller 76 and/or the computing device(s) 78 are configured, the operations for operating the torque extraction system 50 and/or any other operations or functions of the one or more computing device(s) 78. The instructions 78C can be software written in any suitable programming language or can be implemented in hardware. Additionally, and/or alternatively, the instructions 78C can be executed in logically and/or virtually separate threads on processor(s) 78A. The memory device(s) 78B can further store data 78D that can be accessed by the processor(s) 78A. For example, the data 78D can include data indicative of power flows, data indicative of turbine engine 100 operating conditions, data indicative of aircraft operating conditions, and/or any other data and/or information described herein.

The computing device(s) 78 can also include a communications interface 78E used to communicate, for example, with the other components of the turbine engine 100 (FIG. 1), the aircraft incorporating the turbine engine 100, the torque extraction system 50, etc. For example, in the embodiment depicted, as noted above, the turbine engine 100 includes one or more sensors 74 for sensing data indicative of one or more parameters of the turbine engine 100 and/or the torque extraction system 50.

The communications interface 78E can include any suitable components for interfacing with one or more network(s), including for example, transmitters, receivers, ports, controllers, antennas, and/or other suitable components. For example, in the embodiment shown, the communications interface 78E is configured as a wireless communication network wirelessly in communication with these components

Referring now to FIGS. 1 and 2, in operation, the torque extraction system 50 may be used to monitor transient vibrational forces acting on the HP rotor 117. As has been noted herein, when thrust on the HP rotor 117 is small, zero, or at the crossover condition (e.g., changing direction from the aft direction to the forward direction), the HP rotor 117 may experience vibrational forces. In these embodiments, the plurality of sensors 74 may track the vibrational forces acting on the HP rotor 117. The controller 76 may read the vibrational forces tracked by the plurality of sensors 74 to determine if the vibrational forces acting on the HP rotor 117 exceed a predetermined threshold. In the event the vibrational forces exceed the predetermined threshold, the electric machine 56 may operate gearbox 134 such that the gearbox 134 increases the amount of torque (e.g., power) drawn by the electric machine 56 from the HP shaft 122.

As the torque extracted from the HP shaft 122 by the electric machine 56 is increased, the axial thrust in the aft direction acting upon the HP rotor 117 may increase. The increase in axial thrust in the aft direction acting upon the HP rotor 117 may lead to a decrease in the vibrational forces acting upon the HP rotor 117. In these embodiments, the electric machine 56 may continue to extract additional torque from the HP shaft 122 until the axial thrust in the aft direction is sufficient to bring the vibrational forces acting on the HP rotor 117 beneath the predetermined threshold.

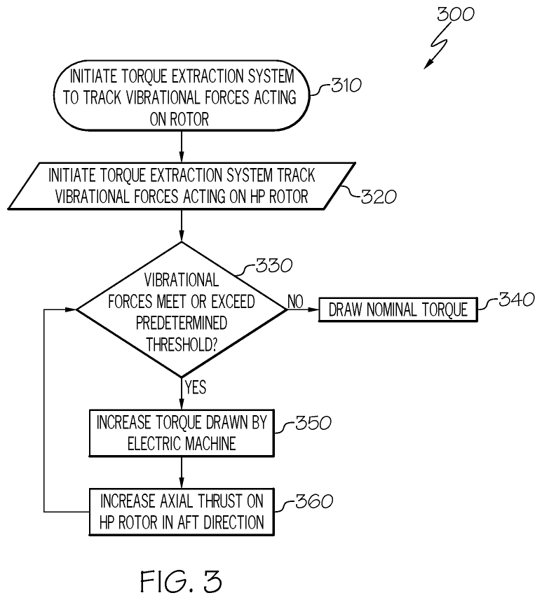

Referring now to FIGS. 2 and 3, FIG. 3 illustrates a flow diagram of a method 300 of extracting torque from a turbine engine using the torque extraction system 50. As depicted in FIG. 3, the method 300 may involve initiating a torque extraction system 50 of a turbine engine to control electric energy drawn by an electric machine 56 from a HP shaft 122, as shown at block 310. For example, to initiate the torque extraction system 50, electric power from the power bus 58 may be provided to the electric machine 56 and the controller 76, such that the electric machine 56 and controller 76 may monitor and control torque drawn by the electric machine 56 from the HP shaft 122.

Referring still to FIGS. 2 and 3, the method 300 may further involve sensing vibrational forces acting on a HP rotor 117 of the turbine engine using a plurality of sensors 74 positioned in the torque extraction system 50, as is depicted at block 320. For example, at least one sensor 74 may be mounted on the HP rotor 117, such that vibrational forces acting on the HP rotor 117 are similarly transferred to the sensor 74, thereby allowing the sensor 74 to relay the sensed vibrational forces to the controller 76.

Turning now to block 330, as the plurality of sensors 74 sense the vibrational forces acting on the HP rotor 117, a controller 76 of the torque extraction system 50 may monitor the vibrational forces to ensure that the vibrational forces acting on the HP rotor 117 do not meet or exceed a predetermined threshold. For example, the controller 76 may continuously receive the vibrational forces sensed by the plurality of sensors 74 to ensure that the predetermined threshold is not met or exceeded. In these embodiments, the controller 76 may monitor the vibrational forces acting on the HP rotor 117 in real time, which may occur simultaneously with the sensing of the vibrational forces by the plurality of sensors 74. In the event the vibrational forces acting on the HP rotor 117 remain below a predetermined threshold, the electric machine 56 may draw nominal torque from the HP shaft 122, as is shown at block 340.

However, in the event the vibrational forces acting on the HP rotor 117 meet and/or exceed the predetermined threshold, the controller 76 may operably increase the torque drawn by the electric machine 56 from the HP shaft 122, as shown at block 350. In these embodiments, the increased torque drawn by the electric machine 56 from the HP shaft 122 may be greater than the nominal torque drawn by the electric machine 56 from the HP shaft 122. As the increased torque is drawn by the electric machine 56 from the HP shaft 122, axial thrust acting on the HP rotor 117 may similarly increase, as shown at block 360. In these embodiments, the torque drawn by the electric machine 56 from the HP shaft 122 may be continually increased until the controller 76 determines that the vibrational forces acting on the HP rotor 117 have fallen beneath the predetermined threshold. Once the vibrational forces acting on the HP rotor 117 have fallen beneath the predetermined threshold, the controller 76 may operably decrease the torque drawn by the electric machine 56 from the HP shaft 122, such that the torque drawn by the electric machine 56 from the HP shaft 122 returns to the nominal torque.

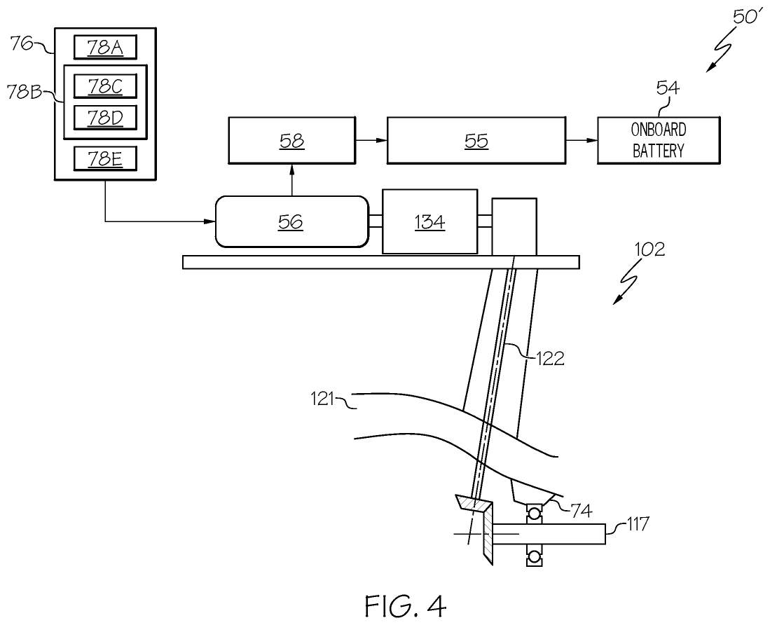

Referring now to FIG. 4, illustrated is a torque extraction system 50′ according to another embodiment and suitable for use in the turbine engine 100 of FIG. 1. The torque extraction system 50′ is similar to the torque extraction system 50 of FIGS. 1-3, therefore, like parts will be identified with like numerals, with it being understood that the description of the like parts of the torque extraction system 50 applies to the torque extraction system 50′ unless otherwise noted. As illustrated in FIG. 4, in some embodiments, the torque extraction system 50′ may further include an electric energy storage unit 55. In these embodiments, the electric energy storage unit 55 may be configured as one or more batteries, such as one or more lithium-ion batteries, or alternatively may be configured as any other suitable electrical energy storage devices. As will be appreciated, the electric energy storage unit 55 may be configured, in certain operating conditions, to receive electrical power from the electric machine, and may further be configured in certain operating conditions to provide stored electrical power to the torque extraction system 50′ and/or other components of the turbine engine.

In the embodiment depicted in FIG. 4, the electric energy storage unit 55 may be electrically coupled to the electric machine 56 by way of the power bus 58, such that electrical energy drawn by the electric machine 56 is transferred to the electric energy storage unit 55. In these embodiments, when the electric machine 56 draws excess torque from the HP shaft 122, the excess torque may be transferred from the electric machine 56 to the electric energy storage unit 55 in the form of electrical energy.

For example, as described herein, the controller 76 of the torque extraction system 50 may increase the torque drawn by the electric machine 56 from the HP shaft 122 when the controller determines that vibrational forces acting upon the HP rotor 117 have exceeded the predetermined threshold. In some embodiments, the increased torque drawn by the electric machine 56 from the HP shaft 122 may be greater than the torque required to diminish the vibrational forces acting on the HP rotor 117 beneath the predetermined threshold. In these embodiments, the excess torque may be transferred from the electric machine 56 to the electric energy storage unit 55 in the form of the electrical power. The electrical power may then be stored in the electric energy storage unit 55 and used to charge additional on-board batteries 54 on the aircraft and/or run additional electric equipment.

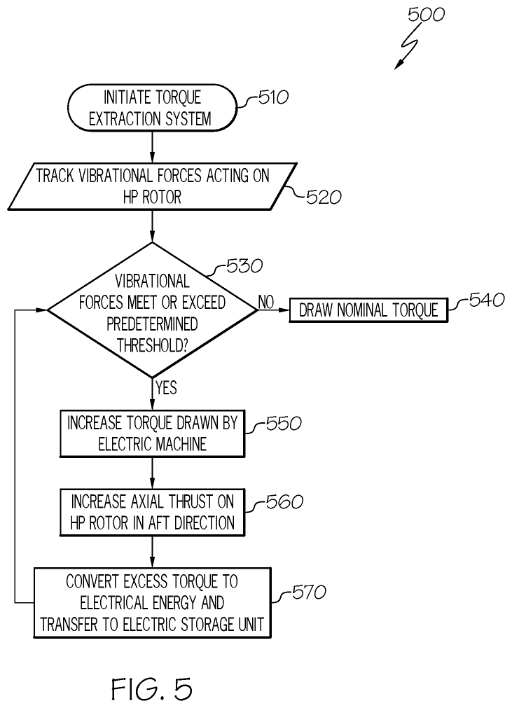

Referring now to FIGS. 4 and 5, FIG. 5 illustrates a flow diagram of a method 500 of extracting torque from a turbine engine using the torque extraction system 50′. As depicted in FIG. 5, the method 500 may involve initiating a torque extraction system 50′ of a turbine engine to control electric energy drawn by an electric machine 56 from a HP shaft 122, as shown at block 510. For example, to initiate the torque extraction system 50′, electric power from the power bus 58 may be provided to the electric machine 56 and the controller 76, such that the electric machine 56 and controller 76 may monitor and control torque drawn by the electric machine 56 from the HP shaft 122.

Referring still to FIGS. 4 and 5, the method may further involve sensing vibrational forces acting on a HP rotor 117 of the turbine engine using a plurality of sensors 74 positioned in the torque extraction system 50′, as is depicted at block 520. For example, at least one sensor 74 may be mounted on the HP rotor 117, such that vibrational forces acting on the HP rotor 117 are similarly transferred to the sensor 74, thereby allowing the sensor 74 to relay the sensed vibrational forces to the controller 76.

Turning now to block 530, as the plurality of sensors 74 sense the vibrational forces acting on the HP rotor 117, a controller 76 of the torque extraction system 50′ may monitor the vibrational forces to ensure that the vibrational forces acting on the HP rotor 117 do not meet or exceed a predetermined threshold. For example, the controller 76 may continuously receive the vibrational forces sensed by the plurality of sensors 74 to ensure that the predetermined threshold is not met or exceeded. In these embodiments, the controller 76 may monitor the vibrational forces acting on the HP rotor 117 in real time, which may occur simultaneously with the sensing of the vibrational forces by the plurality of sensors 74. In the event the vibrational forces acting on the HP rotor 117 remain below the predetermined threshold, the electric machine 56 may draw nominal torque from the HP shaft 122, as is shown at block 540.

However, in the event the vibrational forces acting on the HP rotor 117 meet and/or exceed the predetermined threshold, the controller 76 may operably increase the torque drawn by the electric machine 56 from the HP shaft 122, as shown at block 550. In these embodiments, the increased torque drawn by the electric machine 56 from the HP shaft 122 may be greater than the nominal torque drawn by the electric machine 56 from the HP shaft 122. As the increased torque is drawn by the electric machine 56 from the HP shaft 122, axial thrust acting on the HP rotor 117 may similarly increase, as shown at block 560. In these embodiments, the torque drawn by the electric machine 56 from the HP shaft 122 may be continually increased until the controller 76 determines that the vibrational forces acting on the HP rotor 117 have fallen beneath the predetermined threshold. Once the vibrational forces acting on the HP rotor 117 have fallen beneath the predetermined threshold, the controller 76 may operably decrease the torque drawn by the electric machine 56 from the HP shaft 122, such that the torque drawn by the electric machine 56 from the HP shaft 122 returns to the nominal torque.

Referring still to FIGS. 4 and 5, in some embodiments, the method step of increasing the torque drawn by the electric machine 56 from the HP shaft 122 may result in excess torque being drawn into the electric machine 56. For example, the increased torque drawn by the electric machine 56 may be greater than the torque required to diminish the vibrational forces acting on the HP rotor 117, such that the vibrational forces acting on the HP rotor 117 drop beneath the predetermined threshold. In these embodiments, the excess torque generated by the electric machine 56 may be converted to electrical energy and transferred to an electric energy storage unit 55, as depicted at block 570. The electrical energy transferred to the electric energy storage unit 55 may then be utilized to power other electric equipment within the turbine engine and/or onboard the aircraft. In these embodiments, it should be understood that the method step of transferring excess torque from the electric machine 56 to the electric storage unit 55 may occur simultaneously with the method step of increasing the torque drawn by the electric machine 56 from the HP shaft 122.

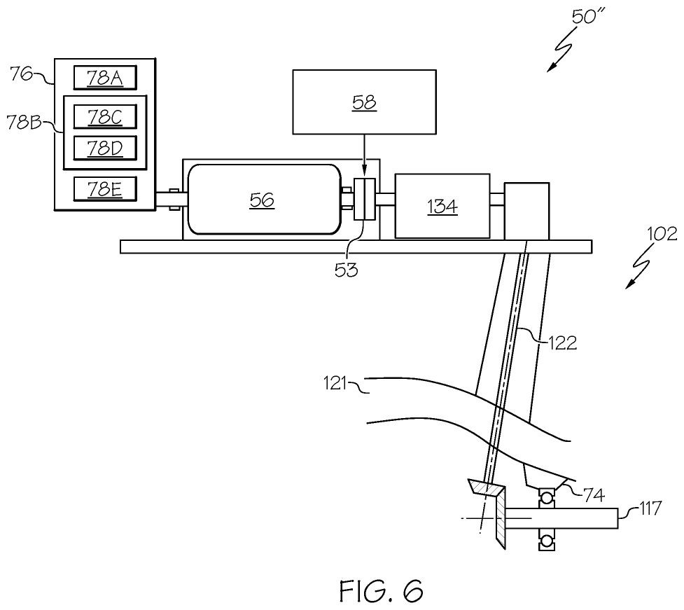

Turning now to FIG. 6, illustrated is a torque extraction system 50″ according to another embodiment and suitable for use in the turbine engine 100 of FIG. 1. The torque extraction system 50″ is similar to the torque extraction system 50 of FIGS. 1-3 and 50′ of FIGS. 4-5, therefore, like parts will be identified with like numerals, with it being understood that the description of the like parts of the torque extraction system 50, 50′ applies to the torque extraction system 50″ unless otherwise noted. As illustrated in FIG. 6 in some embodiments, the electric machine 56 of the torque extraction system 50 may further include a clutch 53. In some embodiments, the clutch 53 may be engaged to a turbine starter system, while in other embodiments, the clutch 53 may act as a mechanical and/or hydraulic braking device coupled to the gearbox 134. As depicted in FIG. 6, the clutch 53 may be disposed between the electric machine 56 and the gearbox 134, such that the clutch 53 may limit interaction between the electric machine 56 and the gearbox 134, as will be described in additional detail herein.

Referring still to FIG. 6, in these embodiments, the clutch 53 may be moved between an engaged position, wherein torque may be transmitted across the clutch 53 from the HP shaft 122 to the electric machine 56, and a disengaged position, wherein torque may not be transmitted across the clutch 53 along the HP shaft 122 to the electric machine 56. In such a manner, the clutch 53 may facilitate operation of the torque extraction system 50″ without rotating the HP rotor 117. Such may be beneficial, particularly during certain ground operations wherein it may be desirable to rotate the turbomachine 102 without creating thrust from the HP rotor 117.

In at least some aspects, the clutch 53 may be a two-stage clutch for transitioning from the disengaged position to the engaged position. For example, such a configuration may allow for operation of the torque extraction system 50″ during, e.g., idle and post-landing operations, without engaging in rotating the HP rotor 117. In such a manner, the electric machine 56 may be sized to accept 100% of a rated engine power, such that the torque extraction system 50 may be operated at a rated engine power without engaging the HP rotor 117 (e.g., by moving the clutch 53 to the engaged position) and having the electric machine 56 convert substantially all of such power to electrical energy to be provided to the aircraft, to one or more energy storage units within or in electrical communication with the aircraft, to assist with starting additional engines, a combination thereof, etc.

Referring still to FIG. 6, it should be understood that, in these embodiments, the controller 76 may be configured to receive data indicative of an engagement status of the clutch (e.g., whether the clutch is in the engaged position or the disengaged position). For example, in some embodiment, the clutch 53 may be configured to transmit a signal to the controller 76 which indicates the engagement status of the clutch 53. In other embodiments, the controller 76 may further include a clutch sensor which senses the engagement status of the clutch 53 and relays the status to the controller 76. In these embodiments, the controller 76 may be further operable to actuate the clutch 53 between the engaged position and the disengaged position in response to the determining that the vibrational forces tracked by the plurality of sensors 74 exceed the predetermined threshold.

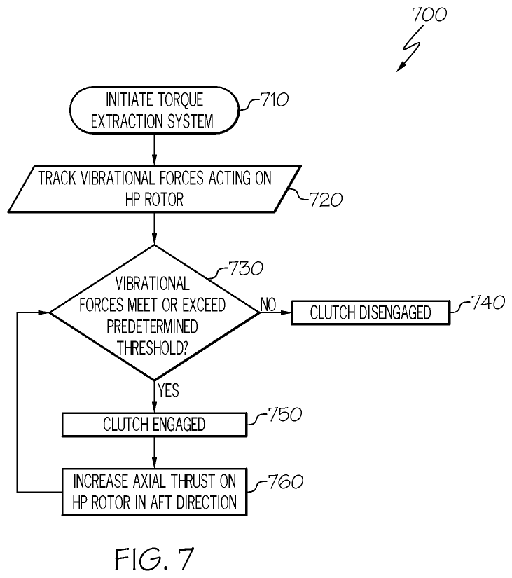

Turning now to FIGS. 6 and 7, FIG. 7 illustrates a flow diagram of a method 700 of extracting torque from a turbine engine using the torque extraction system 50″ is depicted. As depicted in FIG. 7, the method 700 may involve initiating a torque extraction system 50″ of a turbine engine to control electric energy drawn by an electric machine 56 from a HP shaft 122, as shown at block 710. For example, to initiate the torque extraction system 50″, electric power from the power bus 58 may be provided to the electric machine 56 and the controller 76, such that the electric machine 56 and controller 76 may monitor and control torque drawn by the electric machine 56 from the HP shaft 122.

Referring still to FIGS. 6 and 7, in these embodiments, the torque extraction system 50″ may further include a clutch 53 which may be actuatable between an engaged position, in which torque may be transmitted across the clutch 53 from the HP shaft 122 to the electric machine 56, and a disengaged position, wherein torque may not be transmitted across the clutch 53 along the HP shaft 122 to the electric machine 56.

In these embodiments, the method 700 may further involve sensing vibrational forces acting on a HP rotor 117 of the turbine engine using a plurality of sensors 74 positioned in the torque extraction system 50″, as is depicted at block 720. For example, at least one sensor 74 may be mounted on the HP rotor 117, such that vibrational forces acting on the HP rotor 117 are similarly transferred to the sensor 74, thereby allowing the sensor 74 to relay the sensed vibrational forces to the controller 76.

Turning now to block 730, as the plurality of sensors 74 track the vibrational forces acting on the HP rotor 117, a controller 76 of the torque extraction system may monitor the vibrational forces to ensure that the vibrational forces acting on the HP rotor 117 do not meet or exceed a predetermined threshold. For example, the controller 76 may continuously receive the vibrational forces sensed by the plurality of sensors 74 to ensure that the predetermined threshold is not met or exceeded. In these embodiments, the controller 76 may monitor the vibrational forces acting on the HP rotor 117 in real time, which may occur simultaneously with the sensing of the vibrational forces by the plurality of sensors 74. In the event the vibrational forces acting on the HP rotor 117 remain below a predetermined threshold, the clutch 53 may be positioned in the disengaged position, such that torque does not pass from the HP shaft 122 to the electric machine 56.

However, in the event the vibrational forces acting on the HP rotor 117 meet and/or exceed the predetermined threshold, the controller 76 may transition the clutch 53 from the disengaged position to the engaged position, such that torque is drawn by the electric machine 56 from the HP shaft 122, as shown at block 750. In these embodiments, as torque is drawn by the electric machine 56 from the HP shaft 122, axial thrust acting on the HP rotor 117 may increase, as shown at block 760. In these embodiments, the torque drawn by the electric machine 56 from the HP shaft 122 may be continually increased until the controller 76 determines that the vibrational forces acting on the HP rotor 117 have fallen beneath the predetermined threshold. Once the vibrational forces acting on the HP rotor 117 have dropped beneath the predetermined threshold, the controller 76 may further transition the clutch 53 back to the disengaged position, such that torque is not continually drawn by the electric machine 56 from the HP shaft 122.

Referring still to FIG. 7, in some embodiments, the method step of increasing the torque drawn by the electric machine 56 from the HP shaft 122 may result in excess torque being drawn into the electric machine 56. For example, the increased torque drawn by the electric machine 56 may be greater than the torque required to diminish the vibrational forces acting on the HP rotor 117, such that the vibrational forces acting on the HP rotor 117 drop below the predetermined threshold. In these embodiments, the excess torque generated by the electric machine 56 may be converted to electrical energy and transferred to an electric energy storage unit 55 as described above with respect to FIGS. 4 and 5. The electrical energy transferred to the electric energy storage unit 55 may then be utilized to power other electric equipment within the turbine engine and/or onboard the aircraft. In these embodiments, it should be understood that the method step of transferring excess torque from the electric machine 56 to the electric storage unit 55 may occur simultaneously with the method step of increasing the torque drawn by the electric machine 56 from the HP shaft 122.

In view of the above, it should now be understood that at least some embodiments of the present disclosure are directed to a torque extraction system for a turbine engine. During certain turbine engine conditions, vibrational forces may be observed on a rotor of the turbine engine. For example, vibrational forces are typically observed when the axial load on the rotor of the turbine engine is small, zero, or at the thrust crossover condition. If left unchecked, the vibrational forces acting on the rotor can result in non-synchronous vibration issues within the turbine engine. Furthermore, rotors that frequently experience vibrational forces may suffer from high cycle fatigue, which may shorten the life cycle of the rotor or other components of the turbine engine. By implementing a torque extraction system in the turbine engine, it may be possible to monitor vibrational forces acting on a rotor during operation of a turbine engine to ensure that the vibrational forces remain below a predetermined threshold in order to reduce or minimize the aforementioned high cycle fatigue. Furthermore, in the event the vibrational forces exceed the predetermined threshold, the torque extraction system may be operable to extract torque from the rotor to bring the vibrational forces below the predetermined threshold, thereby alleviating potential problems arising from non-synchronous vibration and high cycle fatigue.

A torque extraction system for a turbine engine, comprising: an electric machine coupled to a shaft of the turbine engine by way of a gearbox disposed between the electric machine and the shaft of the turbine engine, such that the electric machine draws torque from the shaft and converts the torque to electrical energy; a power bus electrically coupled to the electric machine, the power bus providing power to the electric machine; a sensor that senses vibrational forces acting on a rotor of the turbine engine; and a controller electrically coupled to the electric machine, the controller receiving signals from the sensor corresponding to the sensed vibrational forces and operating the gearbox disposed between the electric machine and the shaft of the turbine engine to increase the torque that the electric machine draws from the shaft when the vibrational forces sensed by the sensor meet or exceed a predetermined threshold.

The torque extraction system of the preceding clause, wherein the gearbox is operable to adjust a rotational speed of the shaft.

The torque extraction system of any preceding clause, wherein the controller operates the gearbox to increase the torque that the electric machine draws from the shaft by directing the gearbox to adjust the rotational speed of the shaft.

The torque extraction system of any preceding clause, wherein the shaft is a high-pressure shaft and the rotor is a high-pressure rotor.

The torque extraction system of any preceding clause, wherein the controller is a full authority digital engine control controller (FADEC).

The torque extraction system of any preceding clause, further comprising an electric energy storage unit electrically coupled to the electric machine, wherein the electric machine utilizes the power bus to convert excess torque drawn by the electric machine from the shaft to electric energy that is stored in the electric energy storage unit.

The torque extraction system of any preceding clause, wherein the electrical energy stored by the electric energy storage unit is stored in on-board batteries on an aircraft.

The torque extraction system of any preceding clause, wherein the electric machine further includes a clutch coupling the electric machine to the gearbox, the clutch being transitionable between an engaged position and a disengaged position.

The torque extraction system of any preceding clause, wherein the clutch allows the torque to be transmitted across the clutch from the HP shaft to the electric machine in the engaged position, and prevents the torque from being transmitted across the clutch in the disengaged position.

The torque extraction system of any preceding clause, wherein the controller is further configured to transition the clutch coupling the electric machine to the gearbox from the disengaged position to the engaged position when the vibrational forces acting on the rotor increase meet or exceed the predetermined threshold.

A turbine engine, comprising: a turbomachine, the turbomachine comprising: a rotor comprising a turbine, a compressor, and a shaft that drivingly connects the turbine and the compressor; and a torque extraction system comprising: an electric machine coupled to the shaft of the turbomachine by way of a gearbox disposed between the electric machine and the shaft, such that the electric machine draws torque from the shaft as electrical power; a power bus electrically coupled to the electric machine, such that the power bus provides power to the electric machine; a sensor that senses vibrational forces acting on the rotor of the turbomachine; and a controller electrically coupled to the electric machine, the controller receiving signals from the sensor corresponding to the sensed vibrational forces and operates the gearbox disposed between the electric machine and the shaft of the turbine engine to increase the torque that the electric machine draws from the shaft when the vibrational forces sensed by the sensor meet or exceed a predetermined threshold.

The turbine engine of any preceding clause, wherein the gearbox is operable to adjust a rotational speed of the shaft.

The turbine engine of any preceding clause, wherein the controller operates the gearbox to increase the torque that the electric machine draws from the shaft by directing the gearbox to adjust the rotational speed of the shaft.

The turbine engine of any preceding clause, wherein the controller is a full authority digital engine control controller (FADEC).

The torque extraction system of any preceding clause, further comprising an electric energy storage unit electrically coupled to the electric machine, wherein the electric machine utilizes the power bus to convert excess torque drawn by the electric machine from the shaft to electric energy that is stored in the electric energy storage unit.

The turbine engine of any preceding clause, wherein the electric machine further includes a clutch coupling the electric machine to the gearbox, the clutch being transitionable between an engaged position and a disengaged position.

A method for extracting torque from a turbine engine, the method comprising: initiating, using a controller, a torque extraction system of the turbine engine, the torque extraction system including an electric machine that draws torque from a shaft of the turbine engine; initiating, using the controller, the electric machine, such that the electric machine draws a nominal torque from the shaft of the turbine engine; tracking, using the controller, vibrational forces acting on a rotor of the turbine engine using a plurality of sensors positioned in the torque extraction system; monitoring, using the controller, the vibrational forces acting on the rotor to ensure the vibrational forces acting on the rotor remain below a predetermined threshold; increasing, using the controller, the torque drawn by the electric machine from the shaft of the turbine engine when the vibrational forces acting on the rotor meet or exceed the predetermined threshold; and returning, using the controller, the torque drawn by the electric machine from the shaft of the turbine engine to the nominal torque when the vibrational forces acting on the rotor fall below the predetermined threshold.

The method of any preceding clause, further comprising storing excess torque drawn by the electric machine from the shaft in an electric energy storage unit as electrical energy.

The method of any preceding clause, further comprising providing the electrical energy stored in the electric energy storage unit to the turbine engine.

The method of any preceding clause, wherein the electric machine further comprises a clutch, and the method increasing the torque drawn by the electric machine involves transitioning the clutch from a disengaged position to an engaged position.

The method of any preceding clause, wherein the method step of returning the torque drawn by the electric machine from the shaft to the nominal torque involves transitioning the clutch from the engaged position to the disengaged position.

The method of any preceding clause, wherein the method step of increasing the torque drawn by the electric machine from the shaft further involves increasing an axial thrust on the rotor in an aft direction.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A torque extraction system for a turbine engine, comprising:
an electric machine coupled to a shaft of the turbine engine by way of a gearbox disposed between the electric machine and the shaft of the turbine engine, such that the electric machine draws torque from the shaft and converts the torque to electrical energy;
a power bus electrically coupled to the electric machine, the power bus providing power to the electric machine;
a sensor that senses vibrational forces acting on a rotor of the turbine engine; and
a controller electrically coupled to the electric machine, the controller receiving signals from the sensor corresponding to the sensed vibrational forces and operating the gearbox disposed between the electric machine and the shaft of the turbine engine to increase the torque that the electric machine draws from the shaft when the vibrational forces sensed by the sensor meet or exceed a predetermined threshold.

2. The torque extraction system of claim 1, wherein the gearbox is operable to adjust a rotational speed of the shaft.

3. The torque extraction system of claim 2, wherein the controller operates the gearbox to increase the torque that the electric machine draws from the shaft by directing the gearbox to adjust the rotational speed of the shaft.

4. The torque extraction system of claim 1, wherein the shaft is a high-pressure shaft and the rotor is a high-pressure rotor.

5. The torque extraction system of claim 1, wherein the controller is a full authority digital engine control controller (FADEC).

6. The torque extraction system of claim 1, further comprising an electric energy storage unit electrically coupled to the electric machine, wherein the electric machine utilizes the power bus to convert excess torque drawn by the electric machine from the shaft to electric energy that is stored in the electric energy storage unit.

7. The torque extraction system of claim 6, wherein the electrical energy stored by the electric energy storage unit is stored in on-board batteries on an aircraft.

8. The torque extraction system of claim 1, wherein the electric machine further includes a clutch coupling the electric machine to the gearbox, the clutch being transitionable between an engaged position and a disengaged position.

9. The torque extraction system of claim 8, wherein the clutch allows the torque to be transmitted across the clutch from the HP shaft to the electric machine in the engaged position, and prevents the torque from being transmitted across the clutch in the disengaged position.

10. The torque extraction system of claim 9, wherein the controller is further configured to transition the clutch coupling the electric machine to the gearbox from the disengaged position to the engaged position when the vibrational forces acting on the rotor increase meet or exceed the predetermined threshold.

11. A turbine engine, comprising:
a turbomachine, the turbomachine comprising:
a rotor comprising a turbine, a compressor, and a shaft that drivingly connects the turbine and the compressor; and
a torque extraction system comprising:
an electric machine coupled to the shaft of the turbomachine by way of a gearbox disposed between the electric machine and the shaft, such that the electric machine draws torque from the shaft as electrical power;
a power bus electrically coupled to the electric machine, such that the power bus provides power to the electric machine;
a sensor that senses vibrational forces acting on the rotor of the turbomachine; and
a controller electrically coupled to the electric machine, the controller receiving signals from the sensor corresponding to the sensed vibrational forces and operating the gearbox disposed between the electric machine and the shaft of the turbine engine to increase the torque that the electric machine draws from the shaft when the vibrational forces sensed by the sensor meet or exceed a predetermined threshold.

12. The turbine engine of claim 11, wherein the gearbox is operable to adjust a rotational speed of the shaft.

13. The turbine engine of claim 12, wherein the controller operates the gearbox to increase the torque that the electric machine draws from the shaft by directing the gearbox to adjust the rotational speed of the shaft.

14. The turbine engine of claim 11, wherein the controller is a full authority digital engine control controller (FADEC).

15. The torque extraction system of claim 11, further comprising an electric energy storage unit electrically coupled to the electric machine, wherein the electric machine utilizes the power bus to convert excess torque drawn by the electric machine from the shaft to electric energy that is stored in the electric energy storage unit.

16. The turbine engine of claim 11, wherein the electric machine further includes a clutch coupling the electric machine to the gearbox, the clutch being transitionable between an engaged position and a disengaged position.

17. A method for extracting torque from a turbine engine, the method comprising:
initiating, using a controller, a torque extraction system of the turbine engine, the torque extraction system including an electric machine that draws torque from a shaft of the turbine engine;
initiating, using the controller, the electric machine, such that the electric machine draws a nominal torque from the shaft of the turbine engine;
tracking, using the controller, vibrational forces acting on a rotor of the turbine engine using a plurality of sensors positioned in the torque extraction system;
monitoring, using the controller, the vibrational forces acting on the rotor to ensure the vibrational forces acting on the rotor remain below a predetermined threshold;
increasing, using the controller, the torque drawn by the electric machine from the shaft of the turbine engine when the vibrational forces acting on the rotor meet or exceed the predetermined threshold; and
returning, using the controller, the torque drawn by the electric machine from the shaft of the turbine engine to the nominal torque when the vibrational forces acting on the rotor fall below the predetermined threshold.

18. The method of claim 17, further comprising storing excess torque drawn by the electric machine from the shaft in an electric energy storage unit as electrical energy.

19. The method of claim 18, further comprising providing the electrical energy stored in the electric energy storage unit to the turbine engine.

20. The method of claim 17, wherein the electric machine further comprises a clutch, and the method increasing the torque drawn by the electric machine involves transitioning the clutch from a disengaged position to an engaged position.
